(19) United States
(12) Patent Application Publication
(10) Pub. No.: US 2007/0132385 A1
(43) Pub. Date: Jun. 14, 2007

(54) Plasma display panel

(75) Inventor: Gi-Young Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/605,436

(22) Filed: Nov. 29, 2006

(30) Foreign Application Priority Data
Nov. 30, 2005 (KR) 10-2005-0115533

(51) Int. Cl. H01J 17/49

(52) U.S. Cl. 313/582

(57) ABSTRACT

A plasma display panel includes a first substrate; a second substrate facing the first substrate with a distance therebetween; barrier ribs disposed between the first substrate and the second substrate and defining a plurality of discharge cells; address electrodes disposed on the first substrate and extending in a first direction; first electrodes and second electrodes disposed on the second substrate in correspondence with the discharge cells and extending in a second direction crossing the first direction; and a dielectric layer disposed on the second substrate and covering the first electrodes and the second electrodes; wherein the dielectric layer has a groove at a position corresponding to a boundary between neighboring ones of the discharge cells.

### CROSS-REFERENCE TO RELATED APPLICATION

This application claims the benefit of Korean Patent Application No. 10-115533 filed on Nov. 30, 2005, in the Korean Intellectual Property Office, the disclosure of which is incorporated herein by reference in its entirety.

### BACKGROUND OF THE INVENTION

1. Field of the Invention

An aspect of the invention relates to a plasma display panel, and more particularly to a plasma display panel having an improved contrast and a reduced reactive power consumption.

2. Description of the Related Art

A plasma display panel (hereinafter referred to as a ‘PDP’) is a display device that forms an image from visible light generated when vacuum ultraviolet (VUV) light emitted from a plasma discharge produced by a gas discharge excites a phosphor material. The PDP makes it possible to have a display device with a very large screen of greater than 60 inches and a thickness of less than 10 cm. Since the PDP is a self-emission device like a CRT, it has excellent color reproduction and does not exhibit distortion caused by a viewing angle like that which occurs in an LCD. Further, the PDP is simpler to manufacture than the LCD, which is an advantage in terms of productivity and cost competitiveness. Therefore, there are high expectations that the PDP will be a next-generation industrial flat display and home television set.

The structure of the PDP has been under development since 1970. A currently well-known PDP structure is an AC-type three-electrode surface discharge structure. In the AC-type three-electrode surface discharge structure, a front substrate faces a rear substrate with a predetermined distance therebetween. Sustain electrodes and scan electrodes are disposed parallel to each other on the front substrate. Address electrodes are disposed on the rear substrate and extend in a direction that crosses a direction in which the sustain electrodes and the scan electrodes. A discharge gas fills a space between the front substrate and the rear substrate. The front substrate and the rear substrate are sealed to each other.

In general, whether or not a gas discharge occurs is determined by address discharges that occur between the scan electrodes corresponding to each display line of the plasma display panel to be independently controlled and the address electrodes facing the scan electrodes. Sustain discharges to control a brightness of a display occur between the sustain electrodes and the scan electrodes located in the same discharge cells.

In the AC-type three-electrode surface discharge structure, a black stripe layer is formed on the front substrate and is parallel to the sustain electrodes and the scan electrodes. The black stripe layer is made of a material having a high resistance. Further, the black stripe layer is formed in a non-discharge area on the front substrate by using a printing method and is annealed along with a dielectric layer formed on the front substrate. Since the black stripe layer is formed in the non-discharge area, reflection of external light is reduced without blocking visible light transmitted through the front substrate, thereby improving an overall contrast of the PDP.

However, the material of which the black stripe layer is made is expensive, which increases a unit cost of the PDP. Moreover, the black stripe layer formed on the front substrate causes a curvature in the dielectric layer formed on the front substrate, thereby causing a margin of the PDP to be narrowed.

### SUMMARY OF THE INVENTION

An aspect of the invention relates to a plasma display panel having an improved contrast and a reduced reactive power consumption that eliminates the need for a black stripe layer by improving the structure of a dielectric layer.

According to an aspect of the invention, a plasma display panel includes a first substrate; a second substrate facing the first substrate with a distance therebetween; barrier ribs disposed between the first substrate and the second substrate and defining a plurality of discharge cells; address electrodes disposed on the first substrate and extending in a first direction; first electrodes and second electrodes disposed on the second substrate in correspondence with the discharge cells and extending in a second direction crossing the first direction; and a dielectric layer disposed on the second substrate covering the first electrodes and the second electrodes; wherein the dielectric layer has a groove at a position corresponding to a boundary between neighboring ones of the discharge cells.

The barrier ribs may include a first barrier member extending in the first direction, and may further include a second barrier member extending in the second direction.

The groove may extend in the second direction. The groove may include a first groove portion extending in the first direction, and a second groove portion extending in the second direction.

A width of the groove measured in a direction crossing a length direction of the groove may be greatest at a surface of the dielectric layer and decrease towards the second substrate. The groove may have a cross-section having a trapezoid shape.

The groove may include an inclined portion that is inclined relative to the second substrate and extends from the surface of the dielectric layer towards the second substrate, and a parallel portion that is parallel to the second substrate. A width of the inclined portion measured in a direction parallel to the second substrate may be greater than a width of the parallel portion measured in the direction parallel to the second substrate.

A maximum depth of the groove measured in a direction perpendicular to the second substrate may be less than a thickness of the dielectric layer measured in the direction perpendicular to the second substrate.

A gas may fill the groove, and a permittivity of the gas may be less than a permittivity of the dielectric layer.

A capacitance between one the first electrodes and a neighboring one of the second electrodes with the groove interposed therebetween may be less than a capacitance between the one of the first electrodes and the neighboring one of the second electrodes without the groove interposed therebetween.

A protective layer may be disposed on the dielectric layer.

Each of the first electrodes and the second electrodes may include a bus electrode extending in the second direction, and extension electrodes extending from the bus electrode towards centers of respective ones of the discharge cells.

The bus electrode may include a metal electrode extending parallel to the groove.

The groove may be a sandblasted groove.

A basic display unit of the plasma display panel may be a pixel; the discharge cells may be divided into groups of discharge cells; each of the groups of discharge cells my include three adjacent ones of the discharge cells having centers at vertices of a triangle; and each of the groups of discharge cells may constitute one pixel of the plasma display panel.

In a plasma display panel according to an aspect of the invention, since a groove is formed on a surface of a front dielectric layer and corresponds to a boundary portion neighboring discharge cells, visible light emitted from the discharge cells towards a front substrate is diffused in the groove. Thus, a portion of the front substrate corresponding to the groove becomes dark in color. As a result, contrast of the plasma display panel can be improved without having to use an expensive, high-resistance black stripe layer as is required in a plasma display panel of the related art, thereby decreasing a material cost and a manufacturing unit cost of the plasma display panel according to an aspect of the invention.

In a plasma display panel according to an aspect of the invention, since the groove is formed by removing a part of the front dielectric layer and there is no high-resistance black stripe layer, a capacitance and a resistance of the plasma display panel according to an of the invention is reduced compared to a plasma display panel of the related art, thereby significantly lowering consumption of reactive power in the plasma display panel according to an aspect of the invention.

In a plasma display panel according to an aspect of the invention, a width of the groove formed on the front dielectric layer can be controlled to reduce crosstalk between neighboring discharge cells.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and/or advantages of the invention will become apparent and more readily appreciated from the following description of embodiments of the invention, taken in conjunction with the accompanying drawings of which:

FIG. 1 is a partially exploded perspective view of a plasma display panel according to a first aspect of the invention;

FIG. 2 is a partial plan view of a front substrate of the plasma display panel of FIG. 1;

FIG. 3 is a partial cross-sectional view taken along the line Ill-Ill of FIG. 1 showing the plasma display panel of FIG. 1 in an assembled state;

FIG. 4 is a partial cross-sectional view taken along the line IV-IV of FIG. 1 showing the plasma display panel of FIG. 1 in the assembled state;

FIG. 5A is a schematic representation of a capacitance between a sustain electrode and a scan electrode in a plasma display panel of the related art;

FIG. 5B is a schematic representation of a capacitance between a sustain electrode and a scan electrode in the plasma display panel of FIG. 1 according to the first aspect of the invention;

FIG. 6 is a circuit diagram of an RC circuit representing an equivalent circuit of the structure of the plasma display panel according to the first aspect of the invention shown in FIG. 5B;

FIG. 7 is a partially exploded perspective view of a plasma display panel according to a second aspect of the invention;

FIG. 8 is a partial plan view of a front substrate of a plasma display panel according to a third aspect of the invention;

FIG. 9 is a partially exploded perspective view of a plasma display panel according to a fourth aspect of the invention; and

FIG. 10 is a partial plan view of a front substrate of the plasma display panel of FIG. 9.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

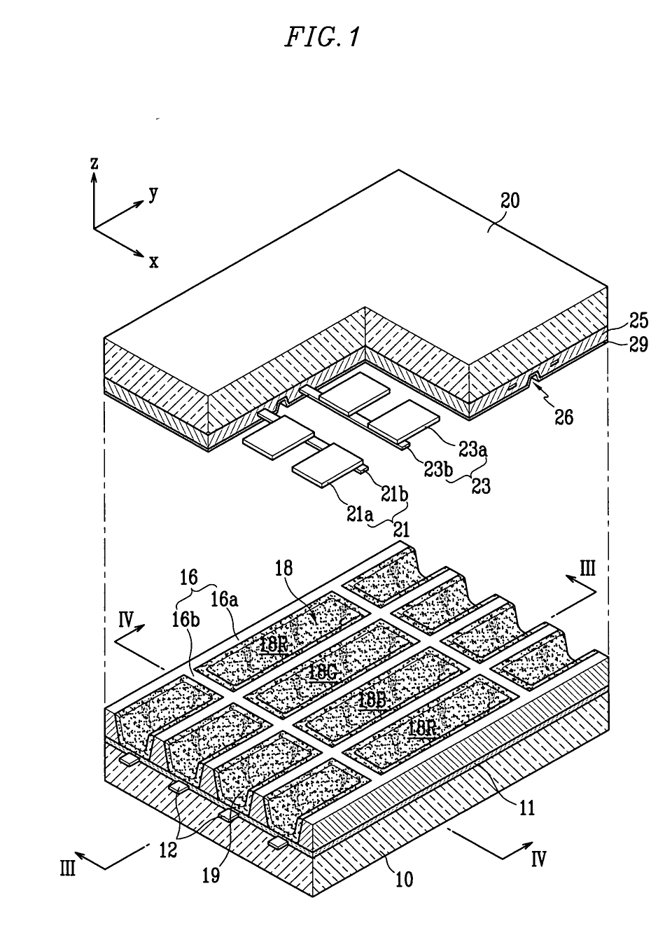

FIG. 1 is a partially exploded perspective view of a plasma display panel according to a first aspect of the invention.

Referring to FIG. 1, the plasma display panel according to the first aspect of the invention includes a first substrate 10 (hereinafter referred to as a ‘rear substrate’) and a second substrate 20 (hereinafter referred to as a ‘front substrate’), wherein the two substrates 10 and 20 face each other with a predetermined distance therebetween. A plurality of discharge cells 18 are defined by barrier ribs 16 between the rear substrate 10 and the front substrate 20. Phosphor layers 19 are formed inside the discharge cells 18. The phosphor layers 19 absorb ultraviolet light emitted from a plasma generated by a gas discharge and emit visible light. In order to generate the plasma discharge, the discharge cells 18 are filled with a discharge gas (e.g., a gas mixture containing xenon (Xe) and neon (Ne)).

Address electrodes 12 are formed on a surface of the rear substrate 10 facing the front substrate 20 and extend in a first direction (the y-axis direction in the drawing). The address electrodes 12 are parallel to one another and are spaced apart by a predetermined distance. The address electrodes 12 pass through the discharge cells 18. Accordingly, the address electrodes 12 generate an address discharge in the discharge cells 18 during an address period in cooperation with corresponding scan electrodes 23 (discussed below), thereby selecting the discharge cells 18 to be turned on.

A dielectric layer 11 (hereinafter referred to as a ‘rear dielectric layer’) is formed on the rear substrate 10 to cover the address electrodes 12. The rear dielectric layer 11 is formed on a front surface of the rear substrate 10 to protect the address electrodes 12.

The barrier ribs 16 are formed on the rear dielectric layer 11 so as to define the discharge cells 18. Each barrier rib 16 includes a first barrier member 16a and a second barrier member 16b. The first barrier member 16a extends in the first direction parallel to the address electrodes 12. The second barrier member 16b extends in a second direction (the x-axis direction in the drawing) crossing the first direction in which the first barrier member 16a extends. The discharge cells 18 are defined by the first barrier members 16a and the second barrier members 16b.

The phosphor layers 19 are formed inside the discharge cells 18. Specifically, the phosphor layers 19 are formed on a side portion of the barrier ribs 16 and on a portion of the rear dielectric layer 11 defined by the barrier ribs 16. The phosphor layers 19 are excited by vacuum ultraviolet light generated by a gas discharge. The excited phosphor layers 19 relax to a ground state, thereby emitting light of a unique color that depends on the particular phosphor used for the phosphor layers 19. Different phosphors may be used for the phosphor layers 19 to obtain emission of different colors of light, such as red, green, and blue. The discharge cells 18 may include discharge cells 18R that emit red light, discharge cells 18G that emit green light, and discharge cells 18B that emit blue light.

First electrodes 21 (hereinafter referred to as ‘sustain electrodes’) and second electrodes 23 (hereinafter referred to as ‘scan electrodes’) are formed on a surface of the front substrate 20 facing the rear substrate 10. That is, the sustain electrodes 21 and the scan electrodes 23 extend in the second direction crossing the first direction and correspond to the discharge cells 18. The scan electrodes 23 generate an address discharge in cooperation with the address electrodes 12 so as to select the discharge cells 18 to be turned on. The sustain electrodes 21 generate a sustain discharge in cooperation with the scan electrodes 23 during a sustain period so as to display an image.

The sustain electrodes 21 and the scan electrodes 23 include bus electrodes 21b and 23b and extension electrodes 21a and 23a. The bus electrodes 21b and 23b extend in the second direction. The extension electrodes 21a and 23a extend from the bus electrodes 21b and 23b towards centers of the discharge cells 18.

In order to increase an aperture ratio of the front substrate 20, the extension electrodes 21a and 23a may be formed of a transparent electrode material such as indium tin oxide (ITO). Although the extension electrodes 21a and 23a have a rectangular planar shape in this aspect of the invention, the invention is not limited to this configuration, and extension electrodes having a different planar shape may be used instead. In order to compensate for a high resistance of the transparent electrode and to obtain a good conductivity, the bus electrodes 21b and 23b may be metal electrodes. In this aspect of the invention, in order for visible light emitted towards the front substrate 20 to be blocked to the minimum extent, the bus electrodes 21b and 23b are disposed at or near the opposite ends of the discharge cells 18.

A dielectric layer 25 (hereinafter referred to as a ‘front dielectric layer’) is formed on the front substrate 20 to cover the sustain electrodes 21 and the scan electrodes 23. Since the front dielectric layer 25 is formed on the front substrate 20, the front dielectric layer 25 may be formed of a transparent dielectric material that can transmit visible light. The front dielectric layer 25 protects the sustain electrodes 21 and the scan electrodes 23 from collisions with electrically charged particles generated when a gas discharge occurs. Wall charges may be accumulated on the front dielectric layer 25 when an address discharge occurs. The accumulated wall charges decrease a discharge ignition voltage when a sustain discharge occurs between the sustain electrodes 21 and the scan electrodes 23.

Grooves 26 are formed on a surface of the front dielectric layer 25 and correspond to boundary portions of discharge cells 18 neighboring one another in the first direction. Specifically, the grooves 26 extend in the second direction and correspond to the second barrier members 16b extending in the second direction. By providing the grooves 26 formed on the surface of the front dielectric layer 25, visible light emitted towards the front substrate 20 is diffused within the grooves 26. This prevents the visible light from being transmitted through the front substrate 20. Accordingly, the boundary portions of the discharge cells 18 corresponding to a non-discharge area become dark in color, thereby improving contrast.

A protective layer 29 may be formed on the front dielectric layer 25. The protective layer 29 may be an MgO protective layer 29. The MgO protective layer 29 protects the front dielectric layer 25 from collisions with electrically charged particles generated when a gas discharge occurs. Further, since electrically charged particles colliding with the MgO protective layer 29 increase a secondary electron emission coefficient, it is possible to increase a discharge efficiency.

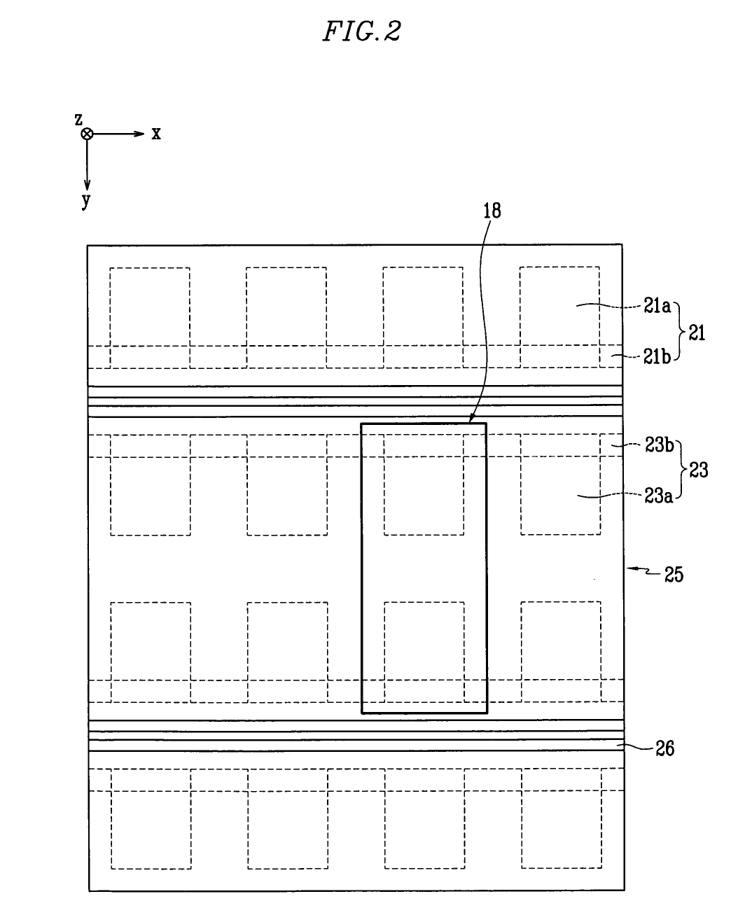

FIG. 2 is a partial plan view of a front substrate of the plasma display panel of FIG. 1.

Referring to FIG. 2, the groove 26 is formed in the second direction (the x-axis direction in the drawing) on a surface of the front dielectric layer 25 covering the front substrate 20. The groove 26 corresponds to a boundary portion of discharge cells 18 neighboring one another in the y-axis direction. Specifically, the groove 26 is formed between the sustain electrode 21, which is disposed in certain ones of the discharge cells 18, and the scan electrode 23, which is disposed in certain other ones of the discharge cells 18 neighboring the certain ones of the discharge cells 18 in the first direction (the y-axis direction in the drawing). Therefore, the groove 26 is formed parallel to the bus electrodes 21b and 23b of the sustain electrode 21 and the scan electrode 23. The groove 26 does not cross the sustain electrode 21 and the scan electrode 23. Accordingly, even if the front dielectric layer 25 is etched to form the groove 26 on its surface, the sustain electrode 21 and the scan electrode 23 buried inside the front dielectric layer 25 will not be exposed to a gas discharge space.

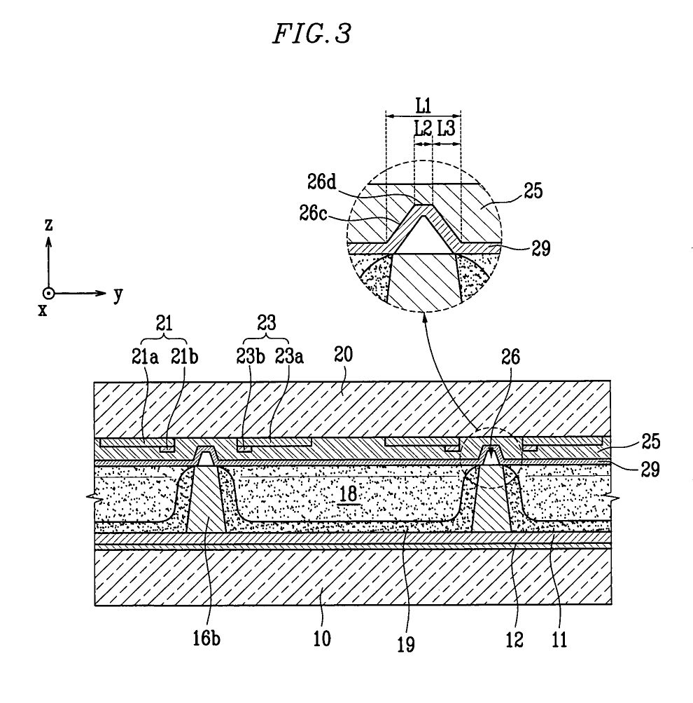

FIG. 3 is a partial cross-sectional view taken along the line III-III of FIG. 1 showing the plasma display panel of FIG. 1 in an assembled state.

Referring to FIG. 3, the groove 26 formed in the second direction (the x-axis direction in the drawing) corresponds to the second barrier member 16b. That is, the groove 26 is located adjacent to the second barrier member 16b and extends continuously in the first direction (the y-axis direction in the drawing).

A width of the groove 26 is measured in a direction crossing a length direction of the groove 26. The width of the groove 26 may be greatest at a surface of the front dielectric layer 25 and may decrease towards the front substrate 20. That is, a width L1 of the groove 26 measured at the surface of the front dielectric layer 25 is greater than a width L2 of the groove 26 measured at a location nearest the front substrate 20. Specifically, the groove 26 includes an inclined portion 26c which is inclined relative to the front substrate 20 and extends from the surface of the front dielectric layer 25 towards the front substrate 20, and a parallel portion 26d that is parallel to the front substrate 20. By providing the inclined portion 26c of the groove 26, visible light emitted towards the front substrate 20 is incident on the inclined portion 26c, thereby being diffused. The diffused visible light substantially cannot be transmitted through the front substrate 20. Accordingly, when viewed from a front surface of the front substrate 20, a portion where the groove 26 is formed becomes dark in color, thereby improving contrast without having to form an additional black stripe layer as is required in a PDP of the related art.

A width L3 of the inclined portion 26c measured in a direction parallel to the front substrate 20 is greater than the width L2 of the parallel portion 26d. That is, since diffusion of visible light mostly occurs in the inclined portion 26c of the groove 26, when the width L3 of the inclined portion 26c is greater than the width L2 of the parallel portion 26d, the visible light emitted towards the groove 26 is further diffused. Thus, the contrast can be further effectively improved.

As shown in FIG. 3, a cross-section of the groove 26 has a trapezoid shape. That is, in this aspect of the invention, the cross-section of the groove 26 has a trapezoid shape that includes the inclined portion 26c and the parallel portion 26d. However, the invention is not limited to the groove 26 having the trapezoid shape, and the groove 26 may have various cross-sectional shapes such as a triangle, a circle, or a polygon.

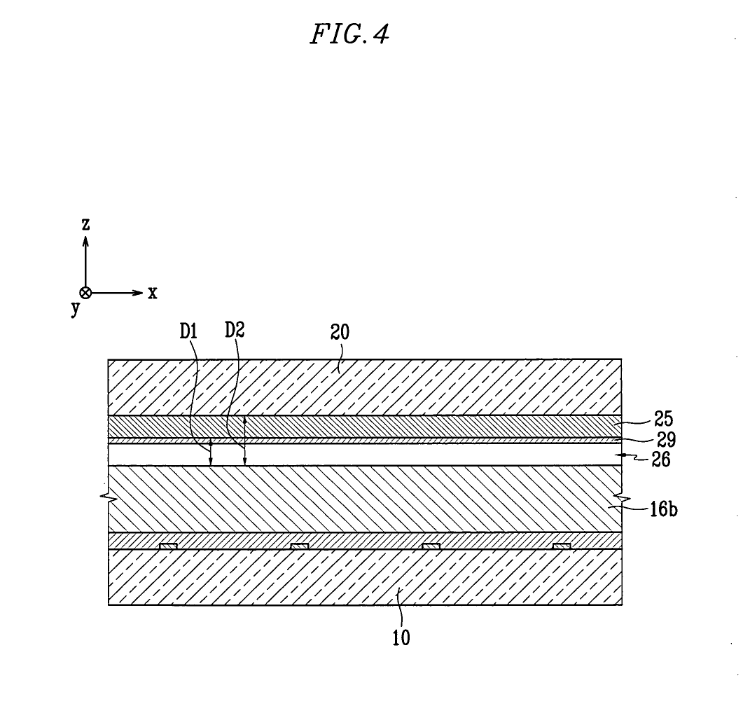

FIG. 4 is a partial cross-sectional view taken along the line IV-IV of FIG. 1 showing the plasma display panel of FIG. 1 in the assembled state.

Referring to FIG. 4, a maximum depth D1 of the groove 26 measured in a direction perpendicular to the front substrate 20 is less than a thickness D2 of the front dielectric layer 25 that is formed on the front dielectric layer 25. The thickness D2 is equal to a distance from an upper surface of the second barrier member 16b to the front substrate 20. When the maximum depth D1 of the groove 26 is less than the thickness D2 of the front dielectric layer 25, the groove 26 extends from the surface of the front dielectric layer 25 towards the front substrate 20, but does not reach the front substrate 20 so that the front substrate 20 covered with the front dielectric layer 25 is not exposed by the groove 26. Accordingly, visible light emitted towards the groove 26 still cannot be transmitted through the front substrate 20, and a portion of the front substrate 20 corresponding to the groove 26 becomes dark in color.

In this aspect of the invention, the groove 26 may be formed using a sandblast method. That is, the front dielectric layer 25 is formed on the front substrate 20, a desired planar shape of the groove 26 is patterned on the front dielectric layer 25 using a mask, and the front dielectric layer 25 is etched by sandblasting, thereby forming the groove 26 with a desired pattern. When the front dielectric layer 25 is etched using the sandblast method, processing conditions, such as a sandblast processing time and other conditions, may be modified so that the groove 26 can be variously patterned in terms of its depth and width. Although the groove 26 is formed using the sandblast method in this aspect of the invention, the invention is not limited to this method, and the groove 26 may be formed on the front dielectric layer 25 by using various other methods such as mechanical cutting or chemical etching.

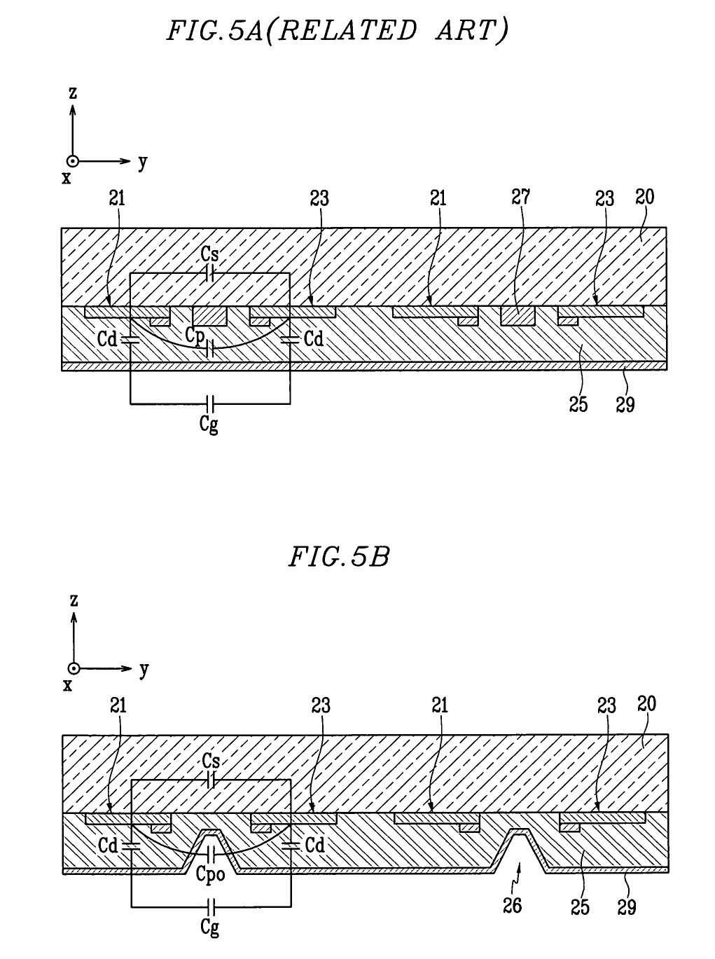

FIG. 5A is a schematic representation of a capacitance between a sustain electrode and a scan electrode in a plasma display panel of the related art, and FIG. 5B is a schematic representation of a capacitance between a sustain electrode and a scan electrode in the plasma display panel of FIG. 1 according to the first aspect of the invention.

Referring to FIG. 5A, a capacitance between a sustain electrode 21 and a scan electrode 23 in a plasma display panel of the related art which are respectively disposed in a pair of discharge cells neighboring one another in a first direction (the y-axis direction in the drawing) is determined by the sum of capacitances of various paths as shown in FIG. 5A. That is, the capacitance between the sustain electrode 21 and the scan electrode 23 is determined by a capacitance Cs of a path from the sustain electrode 21 to the scan electrode 23 via a front substrate 20, a capacitance Cd of a path from the sustain electrode 21 and the scan electrode 23 to a surface of a front dielectric layer 25, a capacitance Cg of a path that starts at the surface of the front dielectric layer 25 and passes through a space containing a discharge gas, and a capacitance Cp of various paths inside the front dielectric layer 25 between the sustain electrode 21 and the scan electrode 23. In the plasma display panel of the related art shown in FIG. 5A, a permittivity of the front dielectric layer 25 is significantly greater than that of a discharge gas. Thus, the capacitance Cp also has a great value.

Further, in the plasma display panel of the related art shown in FIG. 5A, in order to improve contrast, a black stripe layer 27 is formed between the sustain electrode 21 and the scan electrode 23 and extends in a second direction (the x-axis direction in the drawing). In general, the black stripe layer 27 is made of an expensive, high-resistance material. Accordingly, a resistance between the sustain electrode 21 and the scan electrode 23 also increases due to the black stripe layer 27.

On the other hand, referring to FIG. 5B, in the plasma display panel of FIG. 1 according to the first aspect of the invention, since the groove 26 is formed in the second direction (the x-axis direction in the drawing) at a position where the expensive, high-resistance black stripe layer 27 is formed in the plasma display panel of the related art shown in FIG. 5A, a resistance and a capacitance between the sustain electrode 21 and the scan electrode 23 are decreased in comparison with the plasma display panel of the related art shown in FIG. 5A. Specifically, the groove 26 is formed between the sustain electrode 21 and the scan electrode 23 formed in a pair of discharge cells neighboring one another in the first direction. A discharge gas fills the groove 26. The discharge gas has a permittivity that is less than a permittivity of the front dielectric layer 25. Specifically, the permittivity of the front dielectric layer 25 is approximately 12 times higher than the permittivity of the discharge gas in the groove 26. Accordingly, a capacitance Cpo formed by various paths inside the front dielectric layer 25 between the sustain electrode 21 and the scan electrode 23 is smaller than the capacitance Cp of the plasma display panel of the related art shown in FIG. 5A.

The total capacitance C between the sustain electrode 21 and the scan electrode 23 in the plasma display panel of the related art shown in FIG. 5A can be expressed by the following Equation 1.

$$C = {C}_{s} + {C}_{p} + \frac{{C}_{d} {C}_{g}}{{C}_{d} + 2 {C}_{g}} \qquad [ Equation 1 ]$$

The total capacitance Co between the sustain electrode 21 and the scan electrode 23 in the plasma display panel according to the first aspect of the invention shown in FIG. 5B can be expressed by the following Equation 2.

$$C = {C}_{s} + {C}_{po} + \frac{{C}_{d} {C}_{g}}{{C}_{d} + 2 {C}_{g}} \qquad [ Equation 2 ]$$

Since the capacitance Cpo of the plasma display panel according to the first aspect of the invention shown in FIG. 5B is smaller than the capacitance Cp of the plasma display panel of the related art shown in FIG. 5A, the total capacitance C between the sustain electrode 21 and the scan electrode 23 in the plasma display panel according to the first aspect of the invention shown in FIG. 5B is smaller than the total capacitance C between the sustain electrode 21 and the scan electrode 23 in the plasma display panel of the related art shown in FIG. 5A.

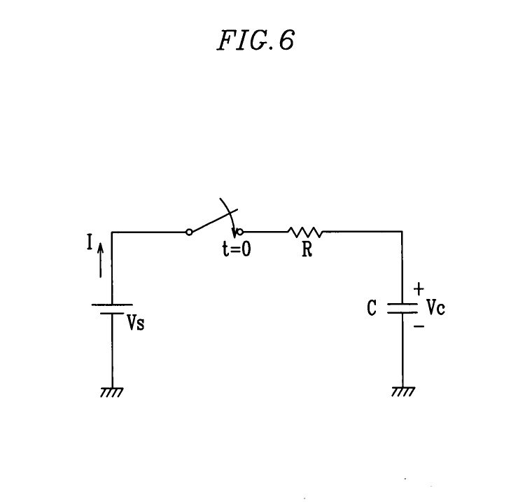

FIG. 6 is a circuit diagram of an RC circuit representing an equivalent circuit of the structure of the plasma display panel according to the first aspect of the invention shown in FIG. 5B.

Referring to FIG. 6, Vs denotes a source voltage, l denotes a current, t denotes time, R denotes a resistance of a resistor, C denotes a capacitance of a capacitor, and Vc denotes a voltage across the capacitor. In this case, if a switch is closed at t=0, the voltage Vc across the capacitor at a time t can be expressed by the following Equation 3 based on Kirchhoff's Law.

$$t \geq 0 , {V}_{S} = R \cdot I ( t ) + \frac{1}{C} {\int }_{0}^{t} I ( t ) ⅆ t + {V}_{C} ( 0 ) \qquad [ Equation 3 ]$$

In this case, if an initial voltage across the capacitor is Vc(0)=0, Equation 3 can be rewritten as the following Equation 4.

$${V}_{C} ( t ) = {V}_{S} ( 1 - {ⅇ}^{- \frac{t}{R C}} ) \qquad [ Equation 4 ]$$

In order to achieve an effective gas discharge, it is preferable to have shorter rising and falling times in a voltage pulse of a externally supplied voltage, that is, a voltage pulse having a steeper slope with respect to a time change. That is, when the slope of the voltage pulse changes rapidly, force applied to an electron for a unit time becomes larger, which leads to an effective gas discharge. As can be confirmed from Equation 4, when an RC value is small, the voltage Vc(t) rapidly reaches a voltage Vs in a steady state. As a result, the externally supplied voltage relatively maintains its original form. That is, if an input voltage pulse is a square wave having a steep slope, an output voltage slowly reaches the voltage Vs in the steady state when the RC value is large. However, when the RC value is small, the output voltage rapidly reaches the voltage Vs in the steady state. Thus, the slope of the output voltage pulse becomes steeper.

That is, the plasma display panel of the related art shown in FIG. 5A has a large RC value due to the presence of the high-resistance black stripe layer 27 and the front dielectric layer 25 without a groove. However, in the plasma display panel according to the first aspect of the invention shown in FIG. 5B, since the high-resistance black stripe layer 27 of the plasma display panel of the related art shown in FIG. 5A is eliminated and the groove 26 is formed in the front dielectric layer 25 at the position of the black stripe layer 27, the RC value is significantly reduced. Accordingly, in the plasma display panel of the first aspect of the invention shown in FIG. 5B, the slope of the output voltage pulse becomes steep, and the output voltage pulse reaches the voltage Vs in the steady state in a short time. Further, since the slope of the output voltage pulse becomes steep, an effective gas discharge occurs in the discharge space, and reactive power consumed in the plasma display panel can be reduced. Most of the reactive power in a plasma display panel is consumed while the output voltage pulse is reaching the voltage Vs in the steady state because during that time, current is flowing through the capacitor C, and the current flowing through the capacitor C leads the voltage across the capacitor C, resulting in reactive power being consumed. Since the output voltage pulse reaches the voltage Vs in the steady state more quickly in the plasma display panel of the first aspect of the invention shown in FIG. 5B than in the plasma display panel of the related art shown in FIG. 5A, the reactive power consumed by in the plasma display panel of the first aspect of the invention shown in FIG. 5B is reduced compared to the plasma display panel of the related art shown in FIG. 5A.

Now, various other aspects of the invention will be described. Since the following aspects of the invention have similar structures that are similar to the structure of the first aspect of the invention shown in FIG. 1, detailed descriptions thereof will be omitted, and only differences will be described.

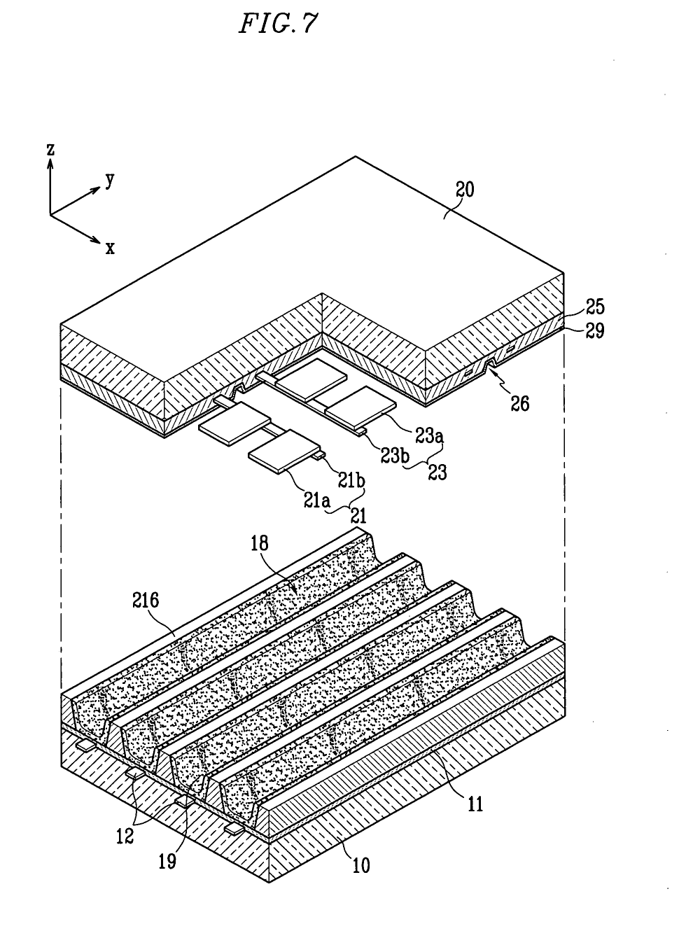

FIG. 7 is a partially exploded perspective view of a plasma display panel according to a second aspect of the invention.

Referring to FIG. 7, barrier ribs of this aspect of the invention have a different shape from those of the first aspect of the invention shown in FIG. 1. That is, in this aspect of the invention, barrier ribs 216 defining discharge cells 18 are formed in a stripe shape parallel to address electrodes 12. A groove 26 is formed in a second direction (the x-axis direction in the drawing) between a sustain electrode 21, which is disposed in certain ones of the discharge cells 18, and a scan electrode 23, which is disposed in certain other ones of the discharge cells 18 neighboring the certain ones of the discharge cells 18 in a first direction (the y-axis direction in the drawing). The groove 26 allows a front substrate 20 to look dark in color at a portion where the groove 26 is formed. Further, overall contrast can be improved without having to use a high-resistance black stripe layer 27 as is required in the plasma display panel of the related art shown in FIG. 5A.

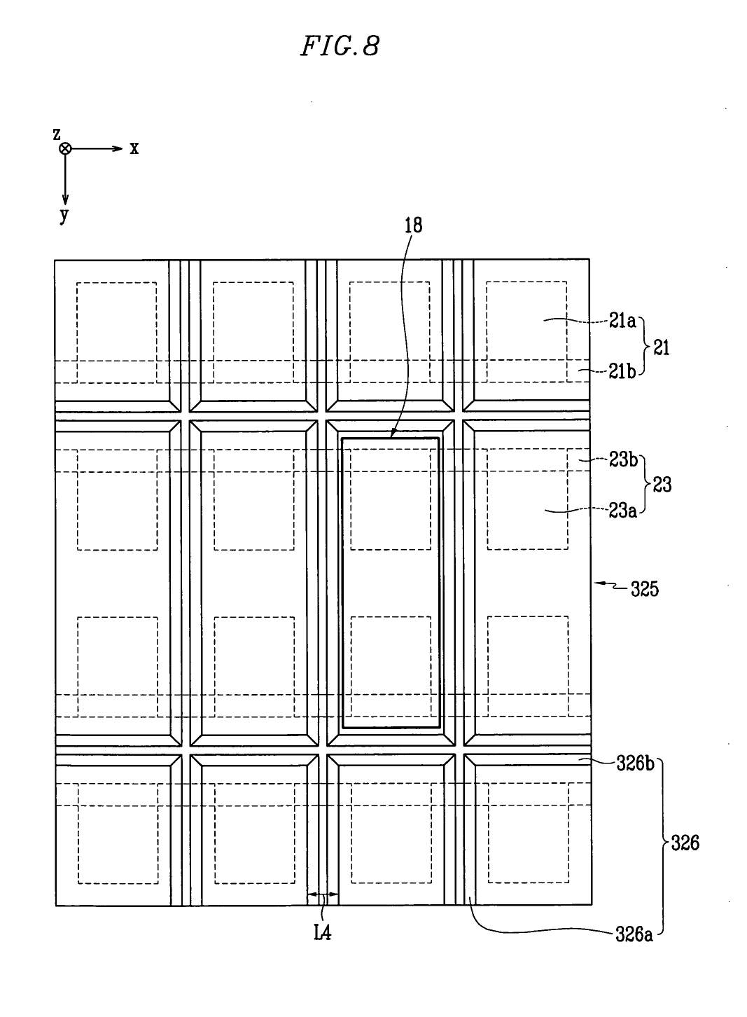

FIG. 8 is a partial plan view of a front substrate of a plasma display panel according to a third aspect of the invention.

Unlike in the first aspect of the invention shown in FIG. 1, a groove also extends in the first direction (the y-axis direction in the drawing) in the third aspect of the invention. That is, in comparison with FIG. 2 showing a front substrate of the plasma display panel of FIG. 1 according to the first aspect of the invention, a groove 326 in the third aspect of the invention includes a first groove portion 326a and a second groove portion 326b. The first groove portion 326a extends in the first direction on a surface of the front dielectric layer 325 and corresponds to a boundary of discharge cells 18 neighboring one another in the second direction (the x-axis direction in the drawing). The second groove portion 326b extends in the second direction on the surface of the front dielectric layer 325 and corresponds to a boundary of the discharge cells 18 neighboring one another in the first direction. The first groove portion 326a and the second groove portion 326b surround the discharge cells 18.

In this case, the first groove portion 326a extends in the first direction which crosses the second direction in which a sustain electrode 21 and a scan electrode 23 extend. Thus, the depth of the first groove portion 326a may be controlled so that the sustain electrode 21 and the scan electrode 23 covered by the front dielectric layer 325 are not exposed by the first groove portion 326a.

When the groove 326 having the structure of this aspect of the invention is formed on the front dielectric layer 325, barrier ribs corresponding thereto may have various shapes. That is, as in the first aspect of the invention shown in FIG. 1, the barrier ribs may have a closed-type matrix shape. In addition, as in the second aspect of the invention shown in FIG. 7, the barrier ribs may have an open-type stripe shape.

A width of the first groove portion 326a measured in a direction crossing a length direction of the first groove portion 326a may be less than an upper width of a barrier rib corresponding to the first groove portion 326a. Thus, crosstalk between the discharge cells 18 neighboring one another in the second direction can be avoided.

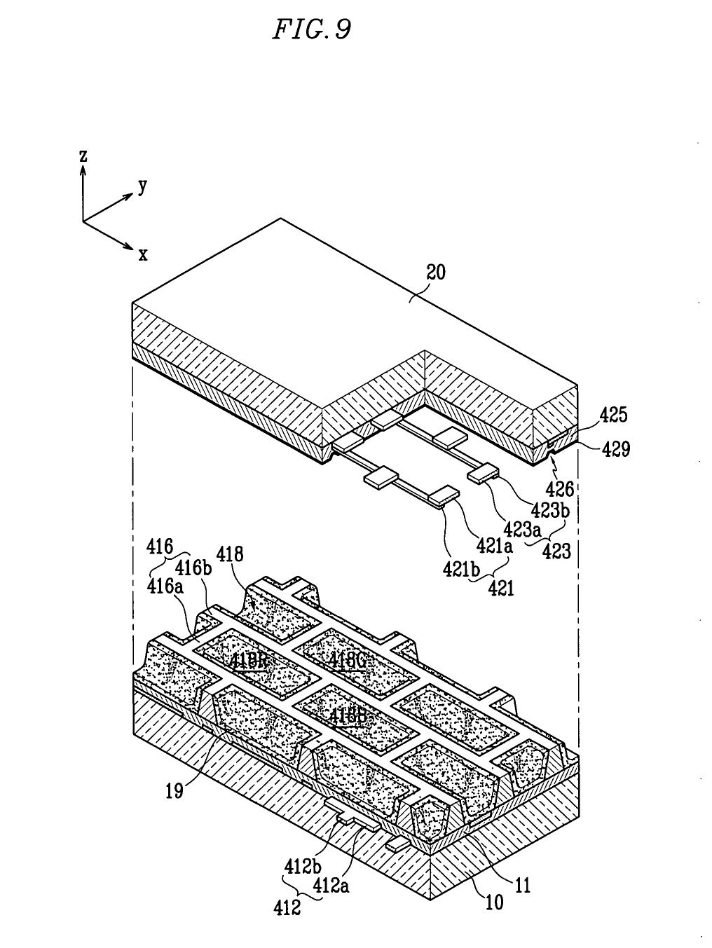

FIG. 9 is a partially exploded perspective view of a plasma display panel according to a fourth aspect of the invention.

In this aspect of the invention, a barrier rib 416 defining discharge cells 418 has a shape different from that in the first aspect of the invention shown in FIG. 1. That is, in this aspect of the invention, discharge cells 418 consecutively arranged along a first row extending in a second direction (the x-axis direction in the drawing) are staggered with respect to discharge cells 418 consecutively arranged along a second row adjacent to the first row. Specifically, the discharge cells 418 in the first row are shifted in the second direction (the x-axis direction in the drawing) by a distance corresponding to half the length of the discharge cells 418 in the second direction with respect to the discharge cells 418 in the second row adjacent to the first row. If a pixel is a basic display unit of the plasma display panel shown in FIG. 9, a group of three adjacent discharge cells 418R, 418G, and 418B having centers at vertices of a triangle constitute one pixel. The discharge cell 418R emits red light, the discharge cell 418G emits green light, and the discharge cell 418B emits blue light.

Thus, the barrier rib 416 includes a first barrier member 416a extending in a first direction (the y-axis direction in the drawing) and a second barrier member 416b extending in the second direction (the x-axis direction in the drawing) and crossing the first barrier member 416a. The first barrier member 416a extends in the first direction at positions that alternate to the left and right relative to the first direction.

According to the positions where the discharge cells 418 and the barrier ribs 416 are disposed, an address electrode 412 extending in the first direction is formed on a rear substrate 10 and passes through the discharge cells 418 in the first row. Further, the address electrode 412 passes along boundaries of the discharge cells 418 in the second row adjacent to the first row. That is, the address electrode 412 includes extended portions 412a corresponding to the discharge cells 418 in the first row and joining portions 412b corresponding to the boundaries of the discharge cells 418 in the second row that join together the extended portions 412a in the first direction. The joining portions 412b are perpendicular to a third direction (the z-axis direction in the drawing) perpendicular to the first barrier member 416a and the rear substrate 10. A similar address electrode 412 in which the extended portions 412a correspond to the discharge cells 418 in the second row and the joining portions 412b correspond to the boundaries of the discharge cells 418 in the first row is also provided. This address electrode structure enables the discharge cells 418 to be respectively selected by the address electrodes 412 having the extended portions 412a corresponding thereto.

A sustain electrode 421 and a scan electrode 423 are formed on the front substrate 20 and extend in the second direction (the x-axis direction in the drawing) along boundaries of the discharge cells 418 neighboring one another in the first direction (the y-axis direction in the drawing). That is, bus electrodes 421b and 423b of the sustain electrode 421 and the scan electrode 423 pass along the boundaries of the discharge cells 418. Extension electrodes 421a and 423b of the sustain electrode 421 and the scan electrode 423 protrude from the bus electrodes 421b and 423b towards the centers of the discharge cells 418, with alternating ones of the extension electrodes 421a and 423b protruding in opposite directions. The sustain electrode 421 and the scan electrode 423 are alternately disposed in the first direction. A front dielectric layer 425 is formed on the front substrate 20 covering the sustain electrode 421 and the scan electrode 423.

A groove 426 is formed in the front dielectric layer 425 formed on the front substrate 20. The groove 426 improves contrast of the plasma display panel without having to use a high-resistance black stripe layer 27 as is required in the plasma display panel of the prior art shown in FIG. 5A. A protective layer 429 which may be an MgO protective layer 429 may be formed on the front dielectric layer 425.

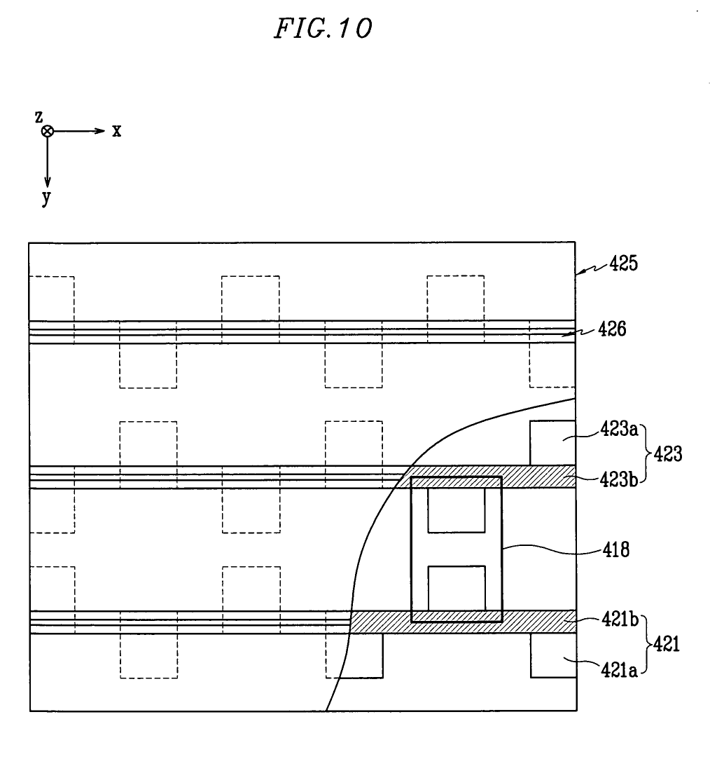

FIG. 10 is a partial plan view of a front substrate of the plasma display panel of FIG. 9.

Referring to FIG. 10, a groove 426 extends in a second direction (the x-axis direction in the drawing). That is, the groove 426 is formed on a surface of a front dielectric layer 425 and corresponds to a boundary of discharge cells 418 neighboring one another in a first direction (the y-axis direction in the drawing). In this case, the depth of the groove 426 may be controlled so that a sustain electrode 421 and a scan electrode 423 covered by the front dielectric layer 425 are not exposed by the groove 426. With the groove 426 having this structure, reflection of external light can be reduced, thereby improving contrast of the plasma display panel. Although not shown in FIG. 10, the groove 426 may be formed to surround the discharge cells 418 like the groove 326 in the third aspect of the invention shown in FIG. 8.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A plasma display panel comprising:
a first substrate;
a second substrate facing the first substrate with a distance therebetween;
barrier ribs disposed between the first substrate and the second substrate and defining a plurality of discharge cells;
address electrodes disposed on the first substrate and extending in a first direction;
first electrodes and second electrodes disposed on the second substrate in correspondence with the discharge cells and extending in a second direction crossing the first direction; and
a dielectric layer disposed on the second substrate and covering the first electrodes and the second electrodes;
wherein the dielectric layer has a groove at a position corresponding to a boundary between neighboring ones of the discharge cells.

2. The plasma display panel of claim 1, wherein the barrier ribs comprise a first barrier member extending in the first direction.

3. The plasma display panel of claim 2, wherein the barrier ribs further comprise a second barrier member extending in the second direction.

4. The plasma display panel of claim 1, wherein the groove extends in the second direction.

5. The plasma display panel of claim 1, wherein the groove comprises:
a first groove portion extending in the first direction; and
a second groove portion extending in the second direction.

6. The plasma display panel of claim 1, wherein a width of the groove measured in a direction crossing a length direction of the groove is greatest at a surface of the dielectric layer and decreases towards the second substrate.

7. The plasma display panel of claim 6, wherein the groove has a cross-section that has a trapezoid shape.

8. The plasma display panel of claim 6, wherein the groove comprises:
an inclined portion that is inclined relative to the second substrate and extends from the surface of the dielectric layer towards the second substrate; and
a parallel portion that is parallel to the second substrate, and
wherein a width of the inclined portion measured in a direction parallel to the second substrate is greater than a width of the parallel portion measured in the direction parallel to the second substrate.

9. The plasma display panel of claim 1, wherein a maximum depth of the groove measured in a direction perpendicular to the second substrate is less than a thickness of the dielectric layer measured in the direction perpendicular to the second substrate.

10. The plasma display panel of claim 1, further comprising a gas filling the groove;
wherein a permittivity of the gas is less than a permittivity of the dielectric layer.

11. The plasma display panel of claim 1, wherein a capacitance between one of the first electrodes and a neighboring one of the second electrodes with the groove interposed therebetween is less than a capacitance between the one of the first electrodes and the neighboring one of the second electrodes without the groove interposed therebetween.

12. The plasma display panel of claim 1, further comprising a protective layer disposed on the dielectric layer.

13. The plasma display panel of claim 1, wherein each of the first electrodes and the second electrodes comprises:
a bus electrode extending in the second direction; and
extension electrodes extending from the bus electrode towards centers of respective ones of the discharge cells.

14. The plasma display panel of claim 13, wherein the bus electrode comprises a metal electrode extending parallel to the groove.

15. The plasma display panel of claim 1, wherein the groove is a sandblasted groove.

16. The plasma display panel of claim 1, wherein a basic display unit of the plasma display panel is a pixel;
wherein the discharge cells are divided into groups of discharge cells;
wherein each of the groups of discharge cells comprises three adjacent ones of the discharge cells having centers at vertices of a triangle; and
wherein each of the groups of discharge cells constitutes one pixel of the plasma display panel.
